(19) United States
(12) Patent Application Publication
(10) Pub. No.: US 2026/0207414 A1
(43) Pub. Date: Jul. 23, 2026

(54) MASSAGING DEVICES AND SYSTEMS FOR TREATING TEMPOROMANDIBULAR JOINT DISORDERS AND METHODS OF USING THE SAME

(71) Applicant: Rachel Jeanette Mahoney, Atlanta, GA (US)

(72) Inventor: Rachel Jeanette Mahoney, Atlanta, GA (US)

(21) Appl. No.: 19/412,162

(22) Filed: Dec. 8, 2025

Related U.S. Application Data
(60) Provisional application No. 63/833,795, filed on Jan. 22, 2025.

(51) Int. Cl. A61H 7/00

(52) U.S. Cl. CPC A61H 7/007; A61H 2007/009; A61H 2201/0228; A61H 2201/10; A61H 2201/1607; A61H 2201/169; A61H 2205/026

(57) ABSTRACT

A massaging system for treatment of temporomandibular joint (TMJ) disorders includes a base plate, a massage head, and support elements. The massage head is coupled to the base plate and has a first position and a second position. In a first configuration, the massage head is placed in the first position and a first support element placed in the base plate. The first support element is used to support a user’s head in a first position and the massage head is used to generate heat and massage treatment for the user’s jaw region. In a second configuration, the massage head is placed in the second position and a second support element placed in the base plate. The second support element is used to support the user’s head in a second position and the massage head is used to generate heat and massage treatment for the user’s jaw region.

### FIELD OF THE INVENTION

This application relates generally to the field of massaging devices and more particularly to massaging devices that provide massage and heat to the jaw area of a person for the treatment of temporomandibular joint (TMJ) disorders.

### BACKGROUND

Temporomandibular joint (TMJ) disorders, also known as temporomandibular joint dysfunction, are a group of conditions that affect the jaw and related muscles. The TMJ is a hinge joint that connects the jaw to the skull, allowing for side-to-side, up-and-down, and other movements. Common symptoms of TMJ disorders include pain in the area of the jaw joint and/or limited jaw movement, clicking and locking.

### SUMMARY

Massaging devices and systems for treating TMJ disorders, and methods of using the same, are disclosed herein.

In accordance with one or more embodiments, a massaging system includes a base plate, a massage head, and one or more support elements. The massage head is coupled to the base plate and has a first upright position and a second folded, lowered position. In a first configuration of the system, the massage head is placed in the first position and a first support element is placed in the base plate. The first support element is used to support a user’s head in a first position and the massage head is used to generate heat and massage treatment for the user’s jaw region. In a second configuration of the system, the massage head is placed in the second position and a second support element is placed in the base plate. The second support element is used to support the user’s head in a second position and the massage head is used to generate heat and massage treatment for the user’s jaw region.

In accordance with another embodiment, a massaging device includes a base plate element, a support element disposed on the base plate element, the support element being adapted to support a head of a user, and a massage head joined to the base plate element. The massage head has a housing and an exterior surface element adapted to contact a jaw region of the user and to provide a heat and massage treatment to the jaw region of the user while the support element supports the head of the user.

In one or more embodiments, an axis of the housing of the massage head is perpendicular to a first surface of the base plate element, The support element includes a cushion adapted to support a back of the head of the user.

In one or more embodiments, an axis of the housing of the massage head is parallel to a first surface of the base plate element. The support element includes a cushion adapted to support a side of the head of the user. The support element includes an aperture adapted to receive a portion of the massage head including the exterior surface element. The portion of the massage head including the exterior surface element is disposed within the aperture of the support element.

In another embodiment, the massage head includes a heating element and a massaging element. The massage head includes a housing and a motor disposed in the housing. The heating element and the massaging element are disposed between the motor and the exterior surface element.

In accordance with an embodiment, a massaging system includes a base plate element having a first surface and a massage head coupled to the base plate element, wherein the massage head includes a housing and an exterior surface. The exterior surface is adapted to provide heat and massage treatment to a jaw region of a user. The massage head has a first position in which an axis of the housing is perpendicular to the first surface of the base plate and a second position in which the axis of the housing is parallel to the base plate. The massage head is adapted to move between the first position and the second position. The system also includes a first support element adapted to fit on the base plate element, the first support element including a first cushion adapted to support a back of a head of a user, and a second support element adapted to fit on the base plate element, the second support element including a second cushion adapted to support a side of a head of the user. The second support element includes an aperture or opening adapted to receive a portion of the massage head including the exterior surface. The massaging system has a first configuration in which the massage head is in the first position and the first support element is disposed on the base plate, and a second configuration in which the massage head is in the second position and the second support element is disposed on the base plate.

In one or more embodiments, the massage head includes a heating element and a massaging element. The massage head may include a housing and a motor disposed in the housing, wherein the heating element and the massaging element are disposed between the motor and the exterior surface element.

In some embodiments, the system also includes a ball joint. The massage head is coupled to the base plate element by the ball joint. The system may also include a locking knob adapted to be loosened to allow the massage head to be rotated and moved to a selected position.

In accordance with another embodiment, a method for providing treatment for TMJ disorders includes arranging the massaging system in the first configuration. While the massaging system is in the first configuration, the first support element is used to support the back of the head of the user, and the massage head is used to provide heat and massage treatment to the jaw region of the user. The massaging system is arranged in the second configuration. While the massaging system is in the second configuration, the second support element is used to support the side of the head of the user, and the massage head is used to provide heat and massage treatment to the jaw region of the user.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a perspective view of a massaging device for treating TMJ disorders in accordance with an embodiment;

FIG. 2 shows a massaging device in a first configuration in accordance with an embodiment;

FIG. 3 shows components of a massaging device in accordance with an embodiment;

FIG. 4 shows a massaging device in a second configuration in accordance with an embodiment;

FIG. 5 shows an exploded view of components of a massaging device in accordance with an embodiment;

FIG. 6 is a perspective view showing a user employing a massaging device in the configuration shown in FIG. 4 in accordance with an embodiment;

FIG. 7 is a perspective view showing a user employing a massaging device in the configuration shown in FIG. 2 in accordance with an embodiment;

FIG. 8 shows a massaging device employed by a user in accordance with another embodiment;

FIG. 9 is a flowchart of a method of using a massaging system and device in accordance with an embodiment; and

FIG. 10 illustrates two positions of a massage head in accordance with an embodiment.

### DETAILED DESCRIPTION

Massaging devices and systems for treating TMJ disorders, and methods of using the same, are disclosed herein.

In accordance with one or more embodiments, a massaging system includes a base plate, a massage head, and one or more support elements. The massage head is coupled to the base plate and has a first upright position and a second folded, lowered position. The massage head is adapted to move between the first and second positions. The massaging system has at least two configurations. In a first configuration of the system, the massage head is placed in the first position and a first support element placed in the base plate. The first support element is used to support a user’s head in a first position and the massage head (in the first position) is used to generate heat and massage treatment for the user’s jaw region. In a second configuration of the system, the massage head is placed in the second folded or lowered position and a second support element is placed in the base plate. The second support element is used to support the user’s head in a second position and the massage head (in the second position) is used to generate heat and massage treatment for the user’s jaw region.

It has been found that deep tissue massage and the application of heat to the jaw hinge area help to alleviate the painful symptoms of TMJ disorders. Existing powered massagers are large and designed to provide a kneading type massage and some heat to areas such as the back or neck but are not designed to accommodate the specific area of the jaw. Furthermore, the amount of heat generated by existing massagers is relatively low and is not effective in providing significant relief for the TMJ condition.

Additionally, it has been found that different individuals prefer different orientations of the massage head during a TMJ massage session. Existing powered massagers do not provide a way to conveniently adjust and lock the angle of the massage and heating head so it can be used in a hands-free manner to deliver optimal massage and heating effects to the jaw area as selected by the user.

Accordingly, there is an ongoing need for powered massagers adapted to provide both the types of massaging and the levels of heat needed to provide relief to individuals suffering from TMJ.

In accordance with an embodiment, an improved massaging device includes a support element adapted to support a user’s head in a position in which the back of the user’s head rests on the support element, and a massage head adapted to contact a side of the user’s head, face, or jaw and provide heat and massage treatment to the side of the user’s head, face, or jaw while the back of the user’s head is supported by the support element. The support element may include one or more cushions. In some embodiments, the massage head is fixed in a position selected to allow the massage head to contact the side of the user’s head, face, or jaw while the back of the user’s head is supported by the support element. In other embodiments, the massage head’s position may be adjusted.

In accordance with another embodiment, a massaging device includes a support element adapted to support a user’s head in a position in which a side of the user’s head, face, or jaw rests on the support element, and a massage head adapted to contact the side of the user’s head, face, or jaw that rests on the support element and provide heat and massage treatment to the side of the user’s head, face, or jaw while the side of the user’s head, face, or jaw is supported by the support element. The support element may include one or more cushions. In some embodiments, the massage head is fixed in a position selected to allow the massage head to contact the side of the user’s head, face, or jaw that is resting on the support element. In other embodiments, the massage head’s position may be adjusted.

In accordance with another embodiment, a massaging system has two configurations that allow a user to receive heat and massage treatment. In a first configuration, the massaging system includes a first support element adapted to support a user’s head in a position in which the back of the user’s head rests on the first support element, and a massage head has a first position and is adapted to contact a side of the user’s head, face, or jaw and provide heat and massage treatment to the side of the user’s head, face, or jaw while the back of the user’s head is supported by the support element. In a second configuration, the massaging device includes a second support element adapted to support a user’s head in a position in which a side of the user’s head, face, or jaw rests on the support element, and the massage head has a second position and is adapted to contact the side of the user’s head, face, or jaw that rests on the support element and provide heat and massage treatment to the side of the user’s head, face, or jaw while the side of the user’s head, face, or jaw is supported by the support element. The massage head is adapted to rotate and/or move between the first and second positions and may be placed in an intermediate position, or in other positions.

In one or more embodiments, a massaging device includes one or more support elements adapted to support a user’s head in a selected position and a massage head element adapted to provide heat and massage treatment to a selected location of a user’s jaw, face, or head while the user’s head is resting on the one or more support elements. The massage head element is adapted to rotate and/or move between a first position in which the massage head provides heat and massage treatment to the user’s jaw, face, or head while the back of the user’s head rests on a first support element of the device and a second position in which the massage head element provides heat and massage treatment to the user’s jaw, face, or head while the side of the user’s head and/or face rests on a second support element of the device.

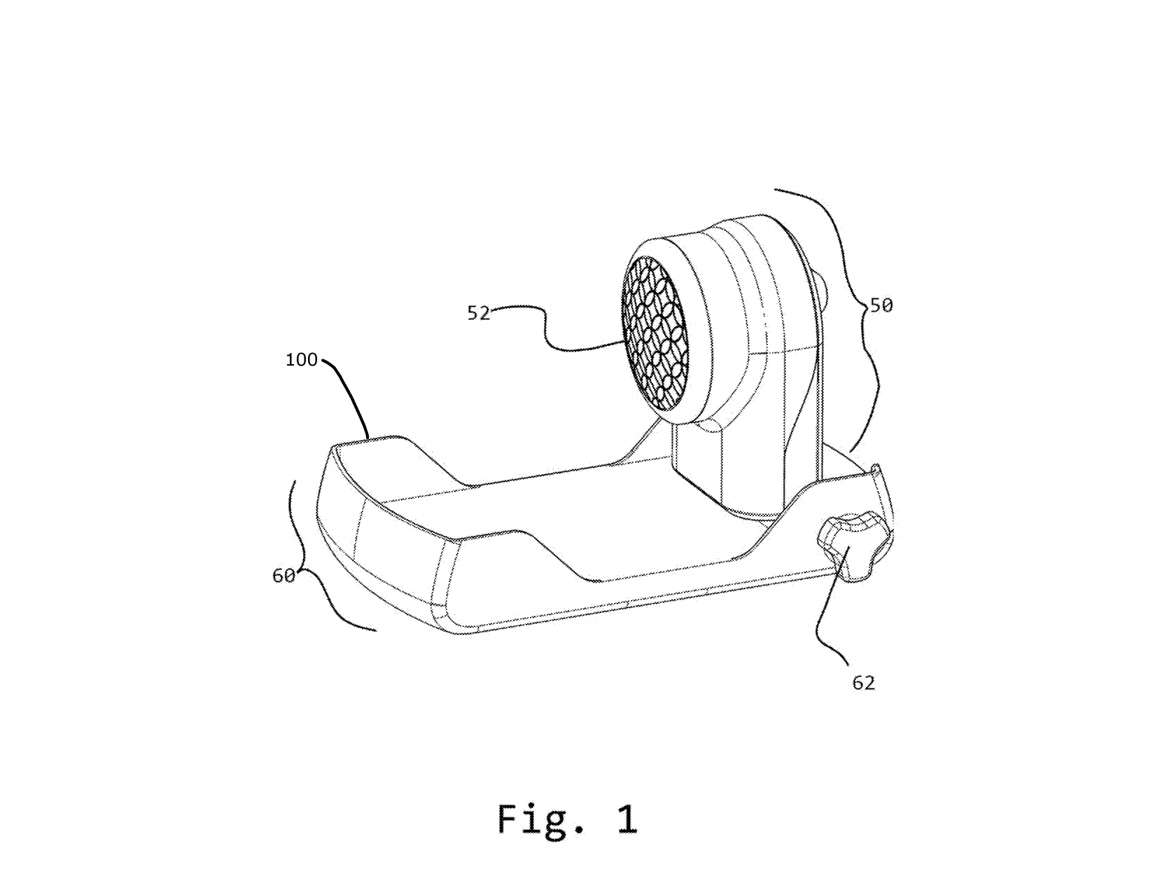

FIG. 1 shows a perspective view of a massaging device 100 for treating TMJ disorders in accordance with an embodiment. Massaging device 100 includes a base plate 60 and a massaging and heating head assembly 50. For purposes of simplicity, the term “massage head” is sometimes used herein in place of the term “massaging and heating head assembly.”

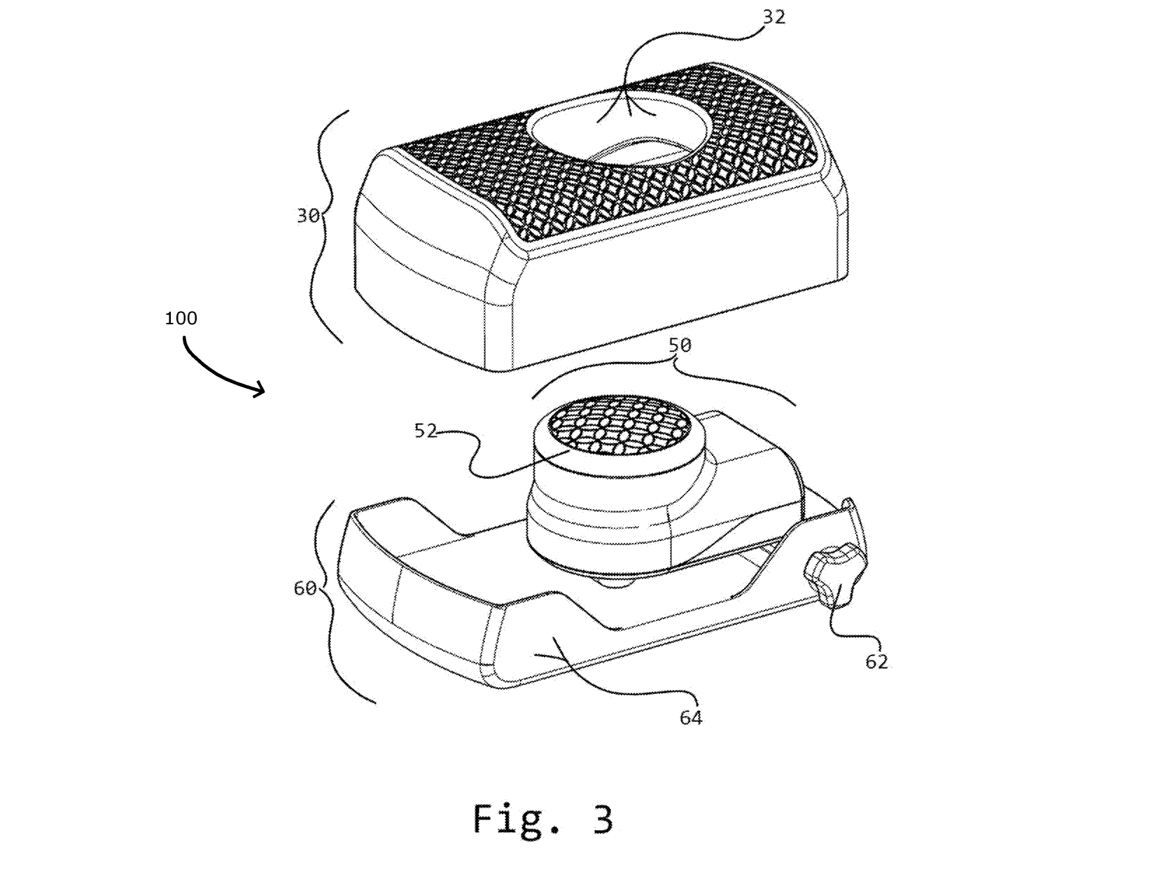

Massage head 50 has an exterior application surface 52. A locking knob 62 disposed on a side of base plate 60 can be adjusted to allow massage head 50 to be rotated and angled and then locked into position as desired by the user. Massage head 50 may be rotated in two different ways – specifically, massage head 50 may rotate or spin on its axis, and massage head 50 may be rotated around a point of connection between massage head and base plate 60. Thus, massage head 50 may rotate from an upright position relative to base plate 60 (as shown in FIG. 1) to a folded or lowered position relative to base plate 60. Massage head 50 may be both rotated on its axis and rotated relative to base plate 60 from a first upright position to a second folded, lowered position (as shown in FIG. 3).

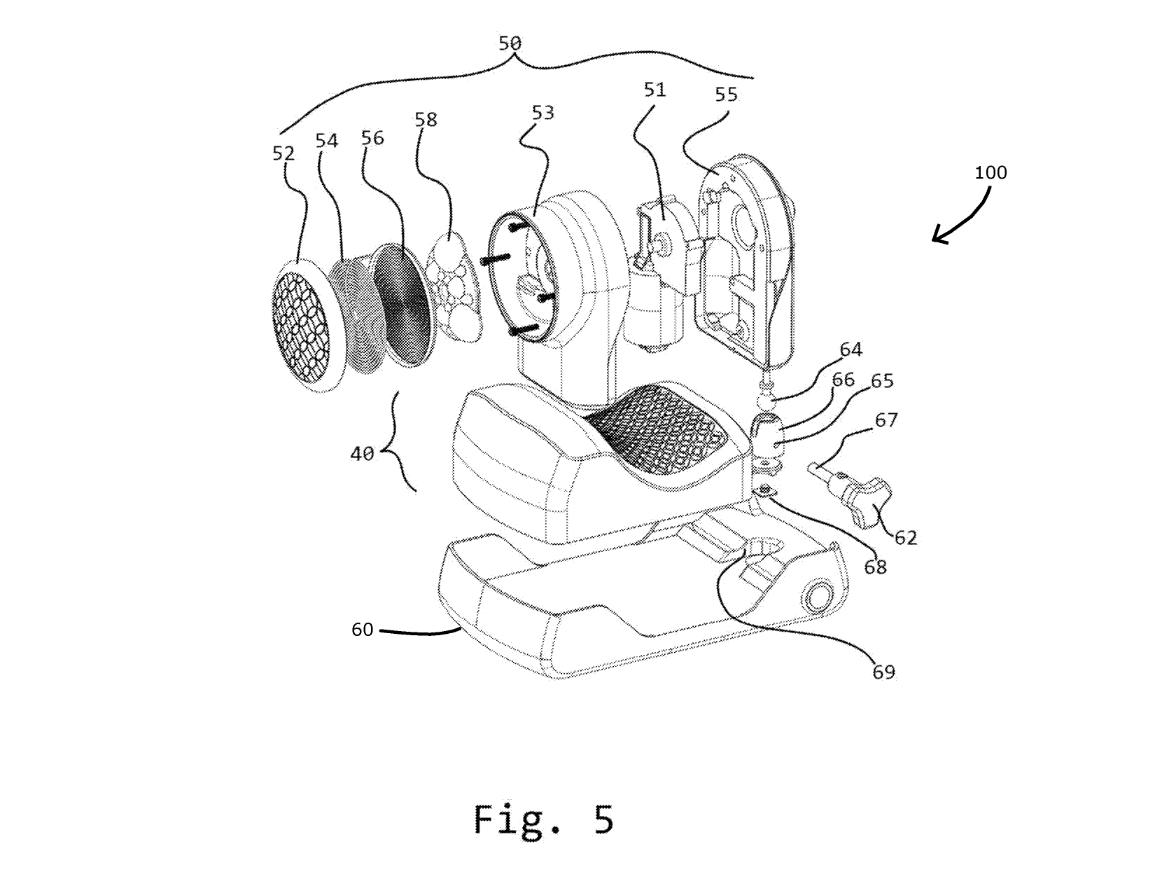

Massage head 50 is mounted to base plate 60 via a lockable ball joint 64, 66 (as shown in FIG. 5). Ball joint 64, 66 allows massage head 50 to rotate around its axis and also to rotate around the ball joint in order to rotate relative to base plate 60 from a first upright position to a second folded, lowered position. The locking knob 62 can be loosened to allow the massage head 50 to be rotated and angled and then locked into position as selected by the user.

In one or more embodiments, massage head 50 is adapted to rotate and/or move between a first upright position (shown in FIG. 1) and a second folded position (shown in FIG. 3). In the illustrative embodiment, when in the first upright position, massage head 50 is positioned such that surface 52 of massage head 50 is perpendicular to, or approximately perpendicular to, base plate 60. Thus, surface 52 and base plate 60 define an angle of approximately ninety (90) degrees. In some embodiments, massage head 50 may be moved to and secured in any intermediate position between the first upright position and second folded position, or positions corresponding to angles greater than ninety (90) degrees relative to base plate 60.

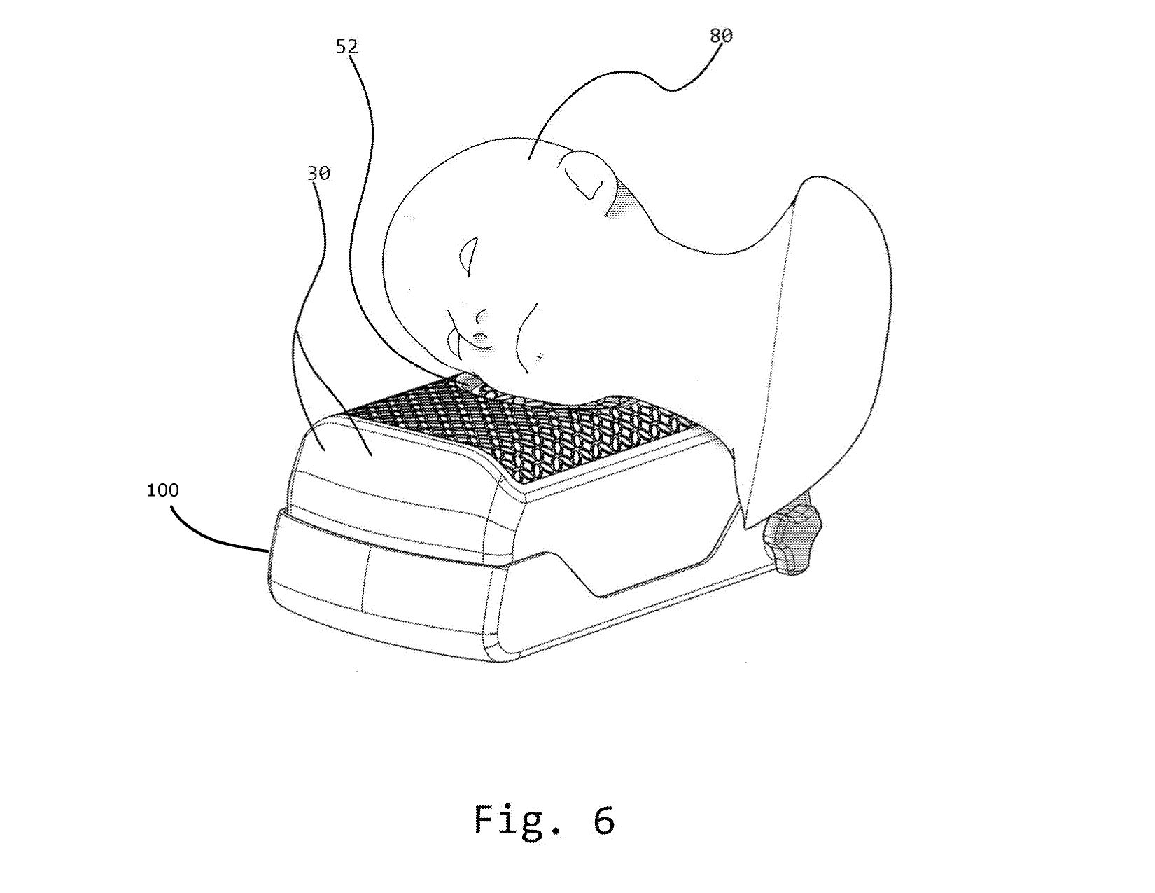

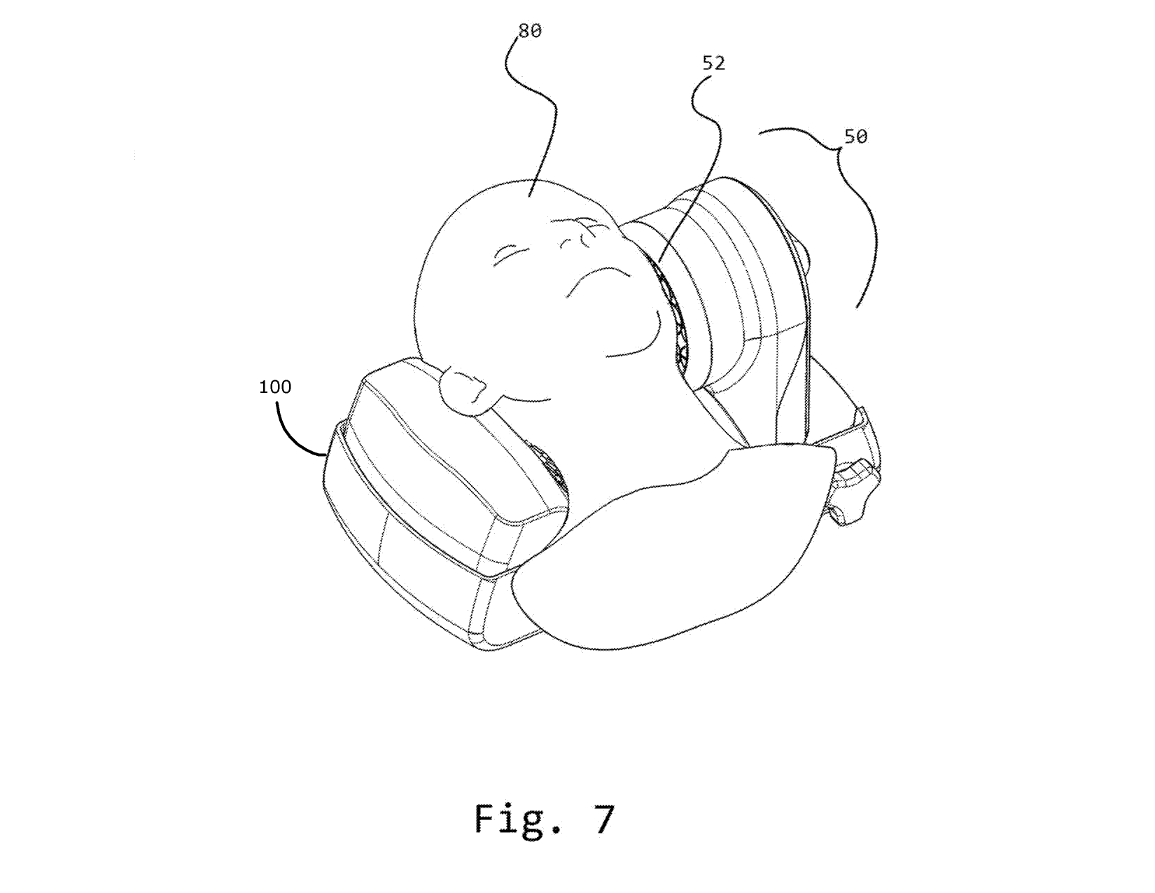

In one or more embodiments, exterior application surface 52 of massage head 50 is adapted to be in intimate contact with the hinge portion of the user’s jaw (as shown in FIGS. 6 and 7).

In one or more embodiments, a support element may include one or more cushions. In one or more embodiments, when massage head 50 is in the first upright position, a first head and neck support cushion may be placed on base plate 60 to enable a user to rest the user’s head on the cushion such that the back of the head contacts and rests on the cushion. Massage head 50 may then be adjusted, if necessary, to contact a desired location on the side of the user’s jaw, face, or head to provide heat and massage treatment while the back of the user’s head is supported by the cushion.

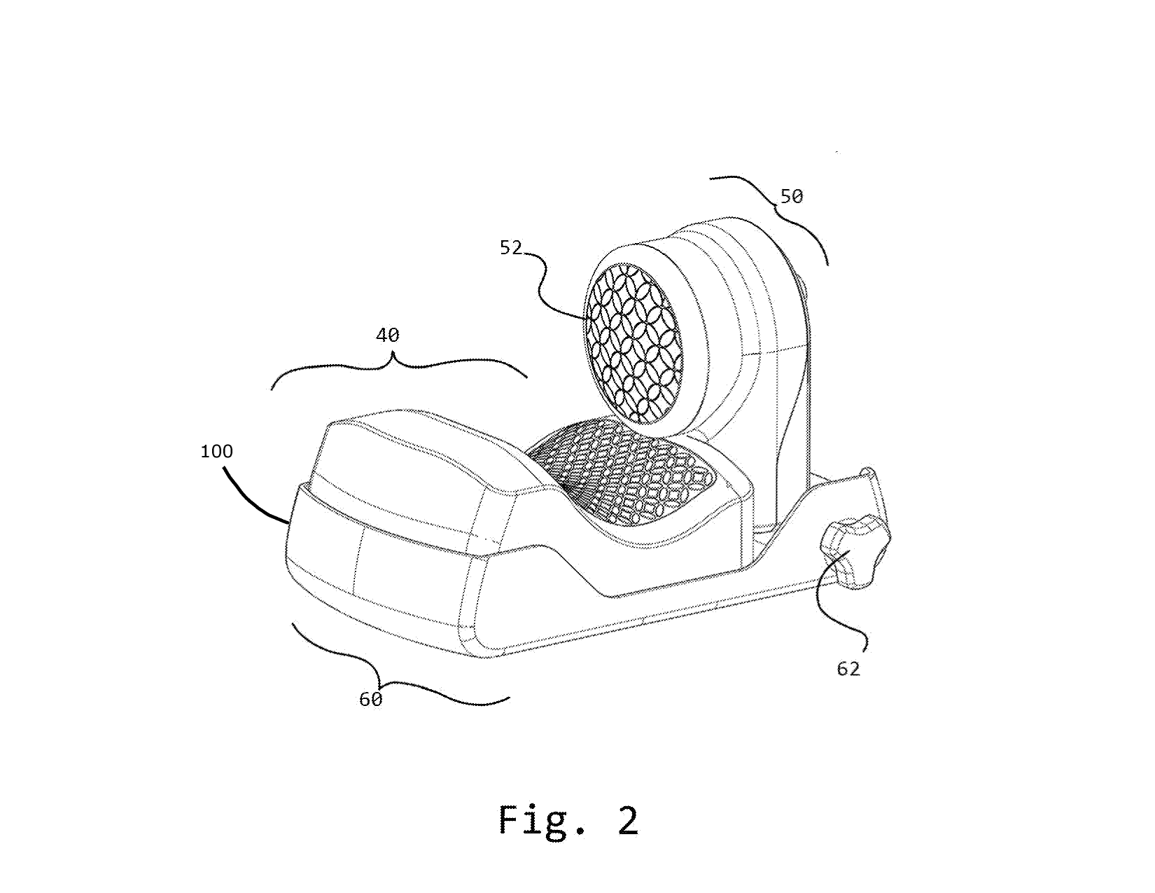

FIG. 2 shows a massaging device in a first configuration in accordance with an embodiment. Massaging device 100 includes massage head 50 in the first upright position and additionally includes a head and neck support cushion 40 disposed in the base plate 60. This configuration allows the user to lie on his or her back with the back of the head supported by cushion 40 (as shown in FIG. 7) and have the surface 52 of massage head 50 in close contact with side of the user’s head and more particularly the user’s jaw hinge area. The user may elect to set the vertical axis of the massage head to greater than ninety degrees or lesser than ninety degrees relative to base plate 60 depending on which angle allows for the most efficacious massage experience. The massage head 50 can also be rotated in the horizontal axis so that the user can adjust and lock the head to any desired angle in the vertical axis or the horizontal axis. The head and neck support cushion 40 is specially designed to cradle the neck and head while allowing the shoulders to rest on a surface parallel to the underside of the base plate 60.

FIG. 3 shows components of a massaging device in accordance with an embodiment. Massaging device 100 includes base plate 60 and massage head 50 and additionally includes a head and neck support cushion 30. Massage head 50 is rotated and/or moved to a position in which the axis of massage head 50 is parallel to, or approximately parallel to, base plate 60 and exterior application surface 52 is facing upward (away from base plate 60). Head and neck cushion 30 includes an aperture 32 and is adapted to be installed on top of the massage head 50 and within the base plate walls 64. Aperture 32 in head and neck support cushion 30 allows the exterior application surface 52 of the massage head 50 to be flush with, or close to, the top surface of cushion 30 allowing a user to lie in a sideways position and rest their jaw on the exterior application surface 52 of the massage head 50 (as shown in FIG. 6).

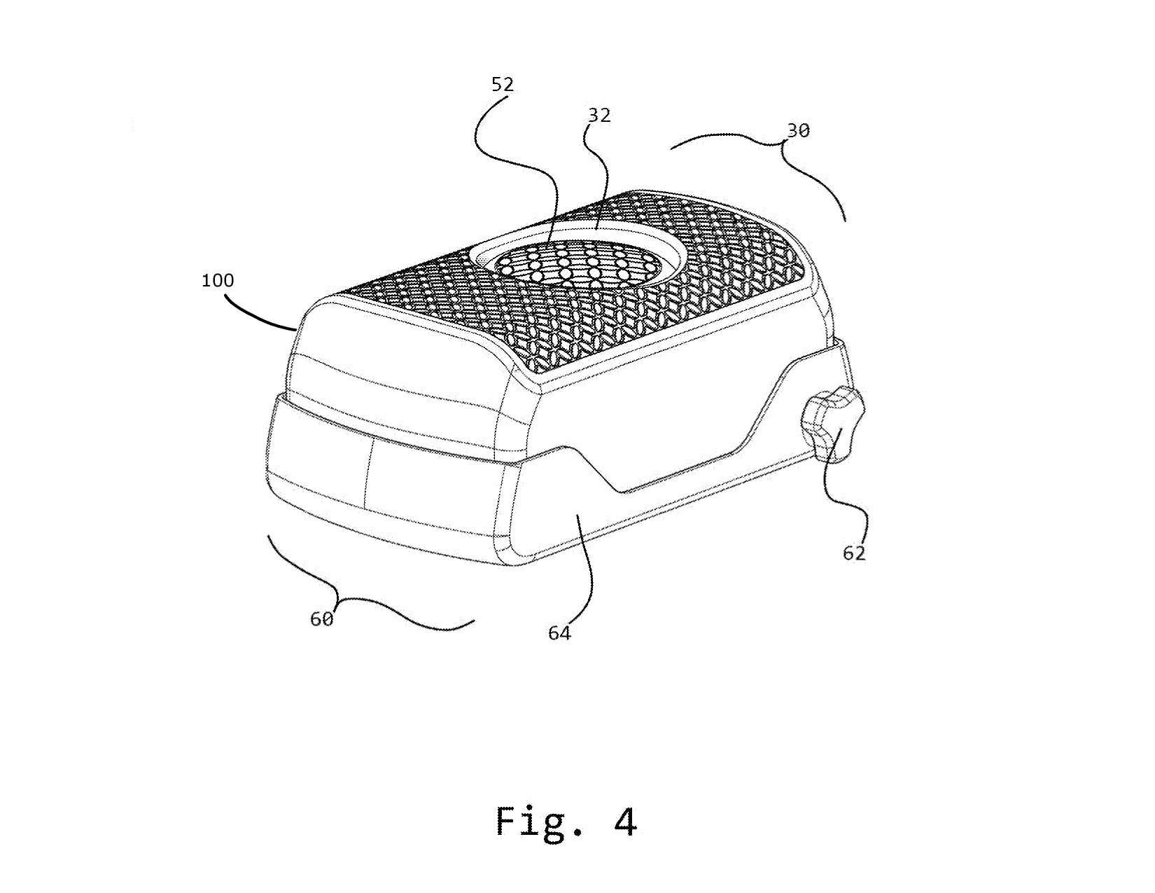

FIG. 4 shows massaging device 100 in the second configuration in accordance with an embodiment. The massaging device shown in FIG. 4 includes the components shown in FIG. 3 in an assembled state. Head and neck cushion 30 is in place within the walls 64 of base plate 60 and exterior application surface 52 of massage head 50 is in place within aperture 32 of cushion 30. In the second configuration shown in FIG. 4, exterior application surface 52 of massage head 50 is slightly recessed relative to the top surface of head and neck support cushion 40. In other embodiments, exterior application surface 52 of massage head 50 is flush with the top surface of head and neck cushion 30. In other embodiments, exterior application surface 52 of massage head 50 is slightly raised relative to the top surface of head and neck cushion 30.

In one or more embodiments, a massaging device includes a massage head in a fixed position and a support element. For example, in an embodiment, a massaging device includes a massage head fixed in the upright position shown in FIGS. 1-2 and a support element such as head and neck support cushion 40 shown in FIG. 2. In another embodiment, a massaging device includes a massage head fixed in the folded, lowered position shown in FIGS. 3-4 and a support element such as head and neck support cushion 30.

In one or more embodiments, a massaging system includes a base plate, a massage head adapted to rotate and/or move between the upright position and the folded, lowered position, and a plurality of interchangeable support elements such as head and neck support cushion 40 and head and neck cushion 30.

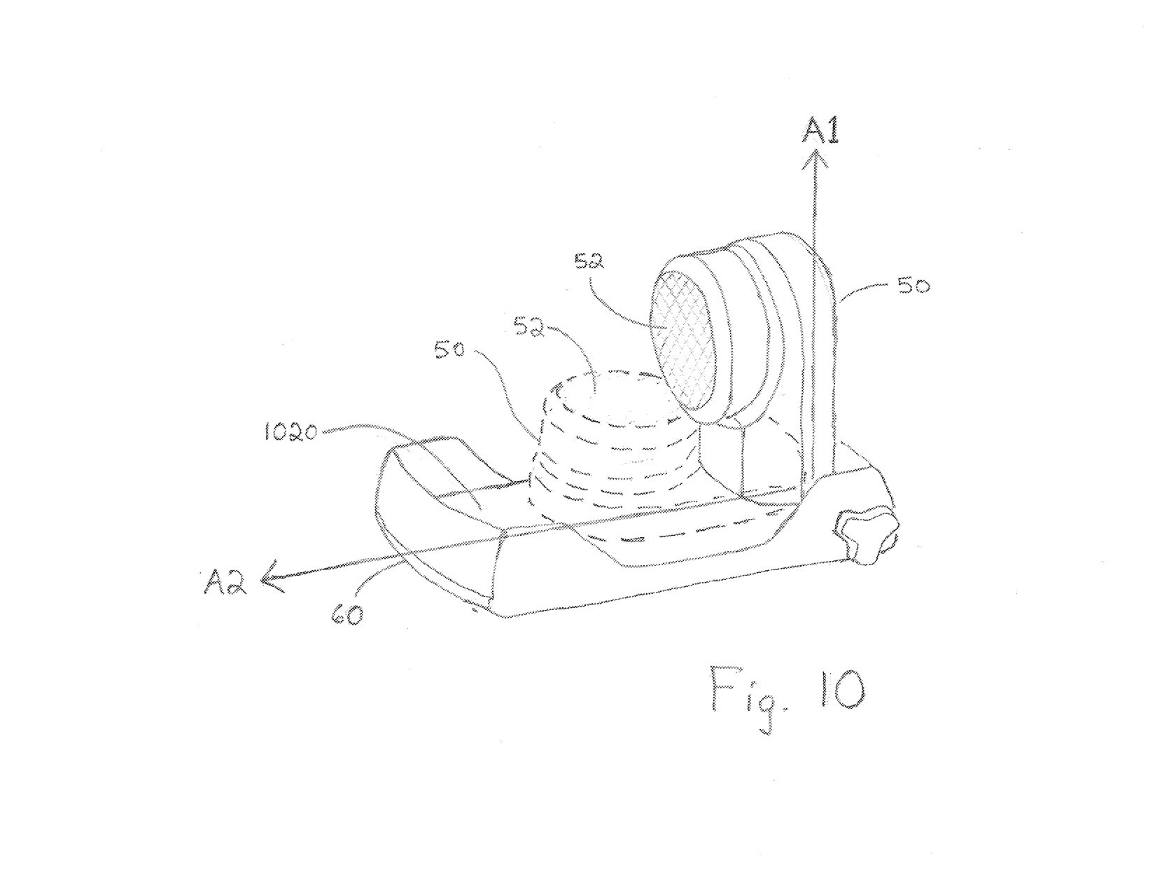

FIG. 10 illustrates two positions of massage head 50 in accordance with one or more embodiments. Massage head 50 is coupled to base plate 60. Base plate has a bottom surface 1020. In a first position, corresponding to the position of massage head 50 shown in FIGS. 1-2, massage head 50 is in an upright position and the housing of massage head 50 has a first axis (A1) that is perpendicular to the bottom surface 1020 of base plate 60. The second position of massage head 50, corresponding to the position of massage head 50 shown in FIGS. 3-4, is shown in phantom. In the second position, massage head 50 is in a folded, lowered position and the housing of massage head 50 has a second axis (A2) that is parallel to the bottom surface 1020 of base plate 60. Axis A1 associated with the first position of massage head 50 and axis A2 associated with the second position of massage head 50 form an angle equal to or approximately equal to ninety (90) degrees. In some embodiments, massage head 50 may be adjusted to any position between the first and second positions, and/or to other positions (e.g., positions associated with angles greater than 90 degrees).

FIG. 5 shows an exploded view of components of a massaging device in accordance with an embodiment. Massage head 50 includes an outer housing formed from housing components 53, 55. The lower portion of housing 55 includes an integral ball member 64 that is enclosed in a ball holding socket 66 which is in turn attached to a retaining plate 68 that is fastened to the base plate 60 at area 69. Locking knob 62 is attached to a threaded member 67 which is inserted to a matching female thread 65 on the side of ball holding socket 66. When the tip of thread member 67 makes firm contact with ball member 64, the entire massage head 50 is locked in place to the desired horizontal or vertical angle. A DC gear motor 51 is retained within the housing (from housing components 55, 53). Massage disk 58 is attached to the shaft of gear motor 51. In one or more embodiments, massage disk 58 includes a surface having a plurality of bumps. In one or more embodiments, massage disk 58 rotates. Massage disk 58 is adapted to produce a massaging effect for treatment of a user’s discomfort. A disc shaped flexible member 56 is placed over the massage disk 58. A flexible heating element 54 is placed over flexible member 56 and a flexible cover plate including exterior application surface 52 is placed over flexible heating element 54. Heating element 54 is adapted to generate heat and provide heat for treatment of a user’s discomfort.

When the user presses his or her jaw against the cover plate (and exterior application surface 52), he or she feels both the kneading action of the massage disk 58 and the heating effect of the flexible heating element 54. The speed of the gear motor 51, as well as the heat intensity of flexible heating element 54, may be adjusted by the user. The adjustment mechanisms for motor speed and heat intensity are well known and not shown in the present drawings. The rotating massage disk 58 or the heating element 54 can be used independently and have independent controls. Support cushion 40 as shown is in a position to be inserted within the side walls of base plate 60.

In one or more embodiments, exterior application surface 52 is adjacent to and placed directly over the flexible heating element 54, without any additional component between surface 52 and heating element 54. Advantageously, this arrangement allows maximum heat transfer from flexible heating element 54 to and through outer surface 52 therefore delivering more concentrated heat to the user’s jaw area as compared to existing shiatsu type massage devices, for example.

In some embodiments, exterior application surface 52 includes a resilient material, which may include, without limitation, 30 shore A silicone rubber, a fabric such as woven polyester, or any other suitable material. Other materials may be used.

In one or more embodiments, flexible heating element 54 is adjacent to flexible member 56 without any additional components between the heating element 54 and flexible member 56. Advantageously, flexible member 56 smooths out the action of the bumps located on massage disk 58 and prevents the bumps of massage disk 58 from disrupting the integrity and operation of the heating element 54.

In one or more embodiments, flexible heating element 54 includes a sandwich of flexible sheets of silicon material which has a flat heating element trapped within. In other embodiments, flexible heating element 54 includes or a flat coiled flexible cable where the outer portion of the cable is made of silicone and the inner portion of the cable is made of heat conducting nichrome wire. Other materials may be used.

In one or more embodiments, flexible member 56 is adjacent to rotating massage disk 58. In one or more embodiments, flexible member 56 includes a resilient flat circular member made of low durometer silicone or flexible PVC material. Other materials may be used.

In one or more embodiments, rotating massage disk 58 is adjacent to housing component 53. Housing component 53 encloses the massage disk 58, flexible member 56, and heating element 54. These elements are enclosed by exterior application surface 52.

In one or more embodiments, rotating massage disk 58 includes injection molded rigid plastic such as ABS or high density polyethylene. Other materials may be used.

Advantageously, the construction illustrated in FIG. 5 allows massage head 50 to be rotated and moved between a first position (as shown in FIG. 1) to a second position (as shown in FIG. 3). When massage head 50 is in the first position, the head and neck support cushion 40 is placed on the base plate 60 (as shown in FIG. 2) and the device may be used by a user to rest the user’s head in a first position, wherein the back of head contacts head and neck support cushion 40. When massage head 50 is in the second position, the head and neck cushion 30 is placed on the base plate 60 (as shown in FIG. 4) and the device may be used by a user to rest the user’s head in a second position, wherein the side of the user’s head and face contact head and neck cushion 30.

FIG. 6 is a perspective view showing a user 80 using the massaging device 100 in the configuration shown in FIGS. 3-4 in accordance with an embodiment. The user’s head rests on support cushion 30, while the user is lying in a sideways position so that the user’s jaw is resting directly on top of the exterior application surface 52 of massage head 50. In this way, the user can apply the weight of her head, approximately ten pounds, creating a downward force that may facilitate the efficacy of the massaging and heating activity of the device. Support cushion 30 helps support the user’s neck and shoulders. The user can horizontally rotate his or her body one hundred and eighty degrees to massage and heat the jaw hinge area on the opposite side of his or her head.

FIG. 7 is a perspective view showing user 80 using the massaging device 100 in the configuration shown in FIG. 2 in accordance with an embodiment. The user’s head rests on support cushion 40, while the user is lying in the supine position with massage head 50 positioned at approximately ninety degrees relative to base plate 60. Support cushion 40 helps to support the user’s neck and head. The massage head 50 may be adjusted to any angle via ball joint 64, 66 (as shown in FIG. 5) so that the user can have a hands-free massage and heat experience directed at the hinge area of the jaw. The user can turn the entire device around one hundred and eighty degrees to massage the jaw area on the opposite side of the user’s head.

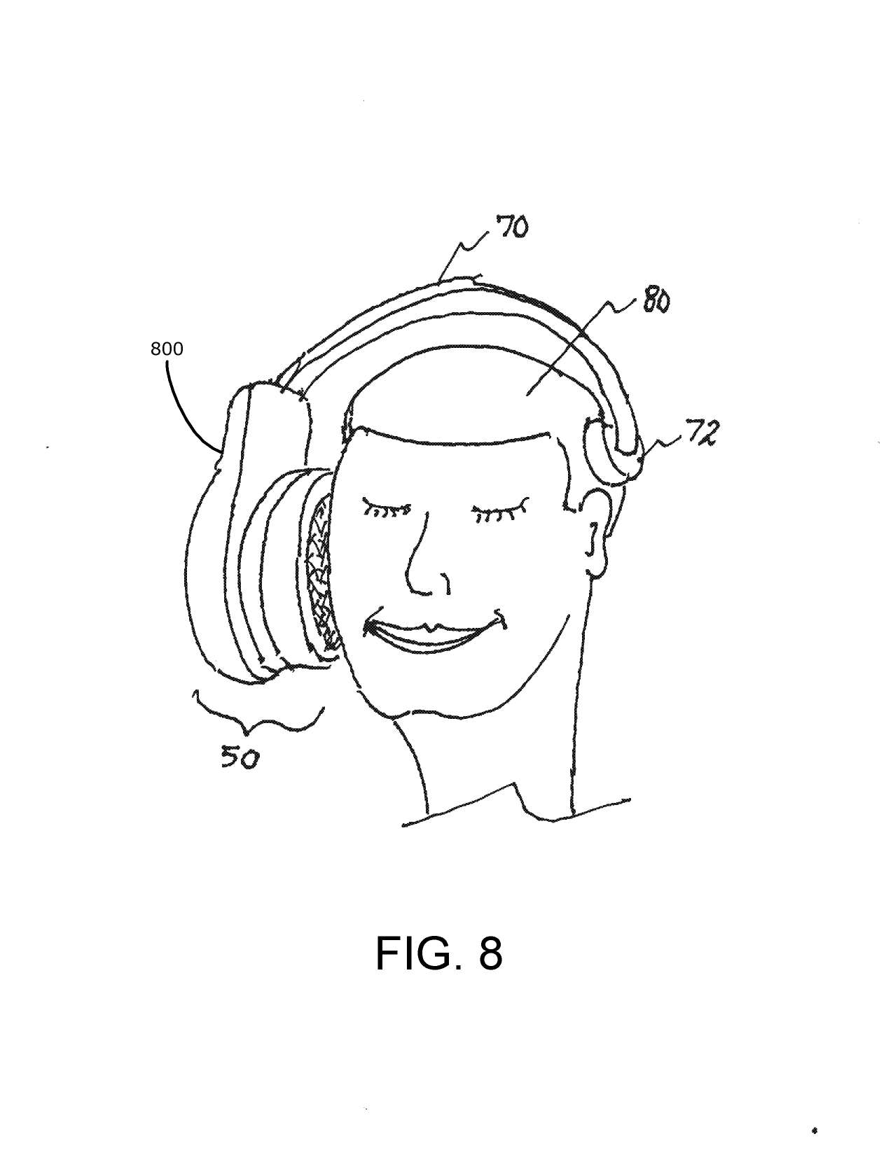

FIG. 8 shows a massaging device 800 employed by a user in accordance with another embodiment. Massaging device 800 includes heating and massage head 50 attached to a headband 70 terminating in a head pad 72 allowing the user to wear the massage and heating head 50 in a manner similar to that used to wear a standard set of headphones.

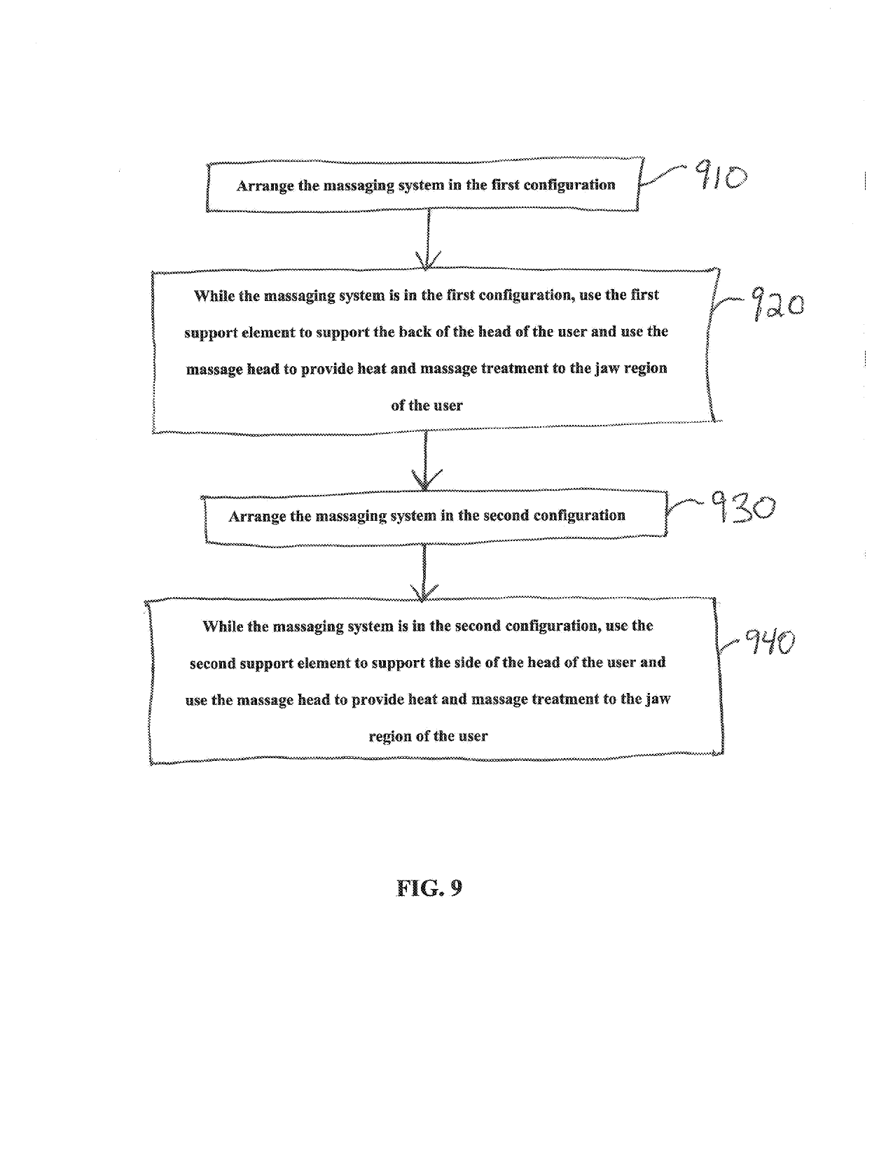

FIG. 9 is a flowchart of a method of using a massaging system and device in accordance with an embodiment. For example, the method of FIG. 9 may be used with massaging devices and systems described herein. At step 910, the massaging system is arranged in the first configuration. Thus, massage head 50 is moved to the first upright position and head and neck support cushion 40 is placed in the base plate 60 (as shown in FIG. 2). At step 920, while the massage system is in the first configuration, the first support element is used to support the back of the head of the user, and the massage head is used to provide heat and massage treatment to the jaw region of a user. Thus, the user may employ the massage system as shown in FIG. 7. At step 930, the massaging system is arranged in the second configuration. Thus, massage head 50 is moved to the second folded and lowered position, and head and neck support cushion 30 is placed in the base plate 60 (as shown in FIG. 4). At step 940, while the massage system is in the second configuration, the second support element is used to support the side of the head of the user, and the massage head is used to provide heat and massage treatment to the jaw region of the user. Thus, the user may employ the massage system as shown in FIG. 6.

Accordingly, in accordance with one or more embodiments, a massaging system includes a base plate, a massage head, and one or more support elements. The massage head is coupled to the base plate and has a first upright position and a second folded, lowered position. In a first configuration of the system, the massage head is placed in the first position and a first support element placed in the base plate. The first support element is used to support a user’s head in a first position and the massage head is used to generate heat and massage treatment for the user’s jaw region. In a second configuration of the system, the massage head is placed in the second position and a second support element placed in the base plate. The second support element is used to support the user’s head in a second position and the massage head is used to generate heat and massage treatment for the user’s jaw region.

In accordance with another embodiment, a massaging device includes a base plate element, a support element disposed on the base plate element, the support element being adapted to support a head of a user, and a massage head joined to the base plate element, the massage head having a housing and an exterior surface element adapted to contact a jaw region of the user and to provide a heat and massage treatment to the jaw region of the user while the support element supports the head of the user.

In one or more embodiments, an axis of the housing is perpendicular to a surface of the base plate element, and the support element includes a cushion adapted to support a back of the head of the user.

In one or more embodiments, the support element includes a cushion adapted to support a side of the head of the user, and an aperture adapted to receive a portion of the massage head including the exterior surface element. The portion of the massage head including the exterior surface element is disposed within the aperture of the support element. An axis of the housing is parallel to a surface of the base plate element.

In another embodiment, the massage head includes a heating element and a massaging element. The massage head may include a housing and a motor disposed in the housing, wherein the heating element and the massaging element are disposed between the motor and the exterior surface element.

In accordance with an embodiment, a massaging system includes a base plate element having a first surface and a massage head coupled to the base plate element, wherein the massage head includes a housing and an exterior surface. The exterior surface is adapted to provide heat and massage treatment to a jaw region of a user. The massage head has a first position in which an axis of the housing is perpendicular to the first surface of the base plate and a second position in which the axis of the housing is parallel to the base plate. The massage head is adapted to move between the first position and the second position. The system also includes a first support element adapted to fit on the base plate element, the first support element including a first cushion adapted to support a back of a head of a user, and a second support element adapted to fit on the base plate element, the second support element including a second cushion adapted to support a side of a head of the user, the second support element having an aperture adapted to receive a portion of the massage head including the exterior surface. The massaging system has a first configuration in which the massage head is in the first position and the first support element is disposed on the base plate, and a second configuration in which the massage head is in the second position and the second support element is disposed on the base plate.

In one or more embodiments, the massage head includes a heating element and a massaging element. The massage head may include a housing and a motor disposed in the housing, wherein the heating element and the massaging element are disposed between the motor and the exterior surface element.

In some embodiments, the system also includes a ball joint, wherein the massage head is coupled to the base plate element by the ball joint. The system may also include a locking knob adapted to be loosened to allow the massage head to be rotated and moved to a selected position.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A massaging device comprising:
a base plate element;
a support element disposed on the base plate element, the support element adapted to support a head of a user; and
a massage head joined to the base plate element, the massage head having a housing and an exterior surface element adapted to contact a jaw region of the user and to provide a heat and massage treatment to the jaw region of the user while the support element supports the head of the user.

2. The massaging device of claim 1, wherein:
an axis of the housing is perpendicular to a first surface of the base plate element;
the support element includes a cushion adapted to support a back of the head of the user.

3. The massaging device of claim 1, wherein:
the support element includes:
a cushion adapted to support a side of the head of the user; and
an aperture adapted to receive a portion of the massage head including the exterior surface element;
the portion of the massage head including the exterior surface element is disposed within the aperture of the support element; and
an axis of the housing is parallel to a first surface of the base plate element.

4. The massaging device of claim 1, wherein the massage head includes a heating element and a massaging element.

5. The massaging device of claim 4, wherein the massage head comprises a housing and a motor disposed in the housing, wherein the heating element and the massaging element are disposed between the motor and the exterior surface element.

6. The massaging device of claim 5, wherein:
the heating element comprises one of a flexible sheet of silicon material including heating component or a coiled flexible cable having an outer portion formed of silicone and an inner portion formed of heat conducting nichrome wire; and
the massaging element comprises an injection molded rigid plastic.

7. A massaging system comprising:
a base plate element having a first surface;
a massage head coupled to the base plate element, the massage head comprising a housing and an exterior surface wherein:
the exterior surface is adapted to provide heat and massage treatment to a jaw region of a user;
the massage head has a first position in which an axis of the housing is perpendicular to the first surface of the base plate and a second position in which the axis of the housing is parallel to the base plate; and
the massage head is adapted to move between the first position and the second position;
a first support element adapted to fit on the base plate element, the first support element comprising a first cushion adapted to support a back of a head of a user; and
a second support element adapted to fit on the base plate element, the second support element comprising a second cushion adapted to support a side of a head of the user, the second support element having an aperture adapted to receive a portion of the massage head including the exterior surface;
wherein the massaging system comprises:
a first configuration in which the massage head is in the first position and the first support element is disposed on the base plate element; and
a second configuration in which the massage head is in the second position and the second support element is disposed on the base plate element.

8. The massaging system of claim 7, wherein the massage head includes a heating element and a massaging element.

9. The massaging system of claim 8, wherein the massage head comprises a housing and a motor disposed in the housing, wherein the heating element and the massaging element are disposed between the motor and the exterior surface element.

10. The massaging system of claim 9, wherein:
the heating element comprises one of a flexible sheet of silicon material including heating component or a coiled flexible cable having an outer portion formed of silicone and an inner portion formed of heat conducting nichrome wire; and
the massaging element comprises an injection molded rigid plastic.

11. The massaging system of claim 7, further comprising a ball joint, wherein the massage head is coupled to the base plate element by the ball joint.

12. The massaging system of claim 11, further comprising a locking knob adapted to be loosened to allow the massage head to be rotated and moved to a selected position.

13. The massaging system of claim 7, wherein:
the second support element comprises an aperture adapted to receive a portion of the massage head including the exterior surface; and
when the system is in the second configuration, the portion of the massage head including the exterior surface is disposed in the aperture of the second support element.

14. A method of using the massaging system of claim 7, the method comprising:
arranging the massaging system in a first configuration;
while the massaging system is in the first configuration:
using the first support element to support the back of the head of the user; and
using the massage head in the first position to provide heat and massage treatment to the jaw region of the user;
arranging the massaging system in the second configuration; and
while the massaging system is in the second configuration:
using the second support element to support the side of the head of the user; and
using the massage head in the second position to provide heat and massage treatment to the jaw region of the user.
